(19) United States
(12) Patent Application Publication
(10) Pub. No.: US 2002/0152131 A1
(43) Pub. Date: Oct. 17, 2002

(54) System and method for intermediating electronic commerce

(76) Inventor: Eun Seog Lee, Seoul (KR)

Correspondence Address: Rosenberg Klein & Lee, Suite 101, 3458 Ellicott Center Drive, Ellicott City, MD, 21043, US

(21) Appl. No.: 09/890,254

(22) PCT Filed: Jul. 11, 2001
(86) PCT No.: PCT/KR01/01188

(30) Foreign Application Priority Data
Jul. 12, 2000 (KR) 2000-40004

(51) Int. Cl. G06F 17/60

(52) U.S. Cl. 705/26

(57) ABSTRACT

The present invention relates to a system and a method for intermediating electronic commerce which enables a user to join multiple cyber malls by a membership registration at one time without a separate authorization procedure for each cyber mall. The system includes Internet accessible user's computers which allow electronic commerce through a program displaying link means connecting service environment display of user's computer, media display and a web page, cyber mall servers which are linked by the link means displayed on a monitor of user's computer and sell products by electronic commerce; and a system server which provides and displays various information and link means to user's computer via the internet, and connects user to the cyber mall servers by membership registration code input once from user's computer without a separate authorization procedure for each cyber mall.

### TECHNICAL FIELD

The present invention relates to a system and a method for intermediating an electronic commerce (hereinafter referred to e-commerce) and especially to a system and a method for intermediating e-commerce which enables a user to join multiple cyber malls by means of membership registration at one time without a separate authorization procedure for each cyber mall.

### BACKGROUND ART

Generally, the e-commerce is similar to the real commerce in which traders participate in the trading of product or services but all or part of the trading in the e-commerce is performed electronically using a network such as the Internet.

In the simplest type of e-commerce, a virtual bank or a credit-card company provides services in the settlement for transactions between a cyber mall and a consumer.

The procedure for the e-commerce includes a steps of shopping by connecting to a cyber mall from a consumer's terminal (computer) which is connected to the Internet, selecting a desired product, transmitting the intention of purchasing, and providing information for settlement.

Thereafter, the cyber mall inquires a virtual bank or a credit card company of the settlement information, requests for the payment and completes the transaction by delivering the requested product to the customer upon payment by the virtual bank or the credit card company.

The technologies related to the e-commerce include an electronic payment system technology in the cyber space, an authorization technology, a searching technology, a cyber mall construction technology and a technology related to a delivery system. Each cyber mall is developing and practicing its own technology.

Conventional cyber mall is doing the job of a guide trading a customer wanted product at the cheapest price. Real trading is performed by connecting to a cyber mall site, inputting membership information and settling expense separately. A buyer has to join the cyber mall by providing required information for authorization for each cyber mall, and has to input a membership ID and a password as well as a URL address of the site in each connection.

As the number of cyber mall increases, there appear cyber malls which equip a searching engine for a product and price for the convenience of a customer's shopping, and carry out purchasing for a customer upon the customer's request.

However, in fact it has the problem that the cyber mall does buying instead of a customer.

Furthermore, the companies affiliated with the cyber mall have to advertise separately for their products and a buyer is provided limited information for a product in the cyber mall because the cyber mall carries out only searching for a product.

Therefore, there is inconvenience in utilizing traditional e-commerce as described above, and there is also a problem of disclosing personal information due to membership registration which requires personal information for each visiting cyber mall.

From the user's point of view, there are inconveniences in visiting many cyber malls because the registered ID and the password for each cyber mall have to be managed and URL address for the cyber malls has to be memorized.

Still furthermore, from the cyber mall's point of view, there is inconvenience such as advertising a product for members separately, and from the user's point of view, information for the same product is provided from several different cyber malls which result in supply of unnecessary information.

### DISCLOSURE OF THE INVENTION

The purpose of the present invention is to provide a system and a method for intermediating e-commerce which enables a user to join multiple cyber malls by means of membership registration at one time to an e-commerce intermediating system without a separate authorization procedure for each cyber mall, and when a user is connected to the intermediating e-commerce system the user can simply and conveniently have product information from multiple cyber malls.

In order to achieve the above object, the present invention provides a system for intermediating e-commerce which comprises Internet accessible multiple user's computers which allow electronic commerce through a program of displaying multiple link means for connecting between service environment display of a user's computer, a media display and a web page; multiple cyber mall servers which are linked by the multiple link means displayed on a monitor of the user's computer and sell products by the electronic commerce; and a system server which provides and displays various information and the link means to the user's computer via the Internet, and connects each user's computer to the multiple cyber mall servers by means of a membership registration code input once from the user's computers without a separate authorization procedure for each cyber mall server.

The system server comprises a web server which connects the system server to the Internet; a homepage database(DB) which stores data including a bulletin board information which is necessary for a homepage operation of the web server; a member DB which stores an information of members who are connected to the system server and uses a provided service; a cyber mall connection server which connects the cyber mall server to the user's computer without a separate membership registration step upon the request of the user to the cyber mall server; a contents connection server which connects the user to a contents provider server upon the request of the user; a news server which searches news provider servers for news to be provided for the user; a news DB which stores a news data found from the news server; an advertisement DB which stores an advertisement data supplied from an advertiser's server; an advertisement sever which transmits the advertisement data stored in the advertisement DB to the user's computer; a media DB which stores a multimedia data to be displayed in the user's computer monitor; a media server which transmits the multimedia data stored in the media DB to the user's computer at a scheduled time or upon the user's request; and a settlement server which intermediates an information for settlement necessary for e-commerce between the user and the cyber mall server.

The system for intermediating the e-commerce further comprising a bank server which pays for the transaction between the user's computer and the cyber mall server and a credit card server which performs a settlement and authorization for transaction through a credit card.

The system for intermediating the e-commerce further comprising multiple advertisers' servers which provide advertisements to be displayed on monitors of users' computers, and multiple contents provider servers which provide a various contents information.

The present invention also provides a method for intermediating an e-commerce comprising the steps of: constructing a network by multiple users' computers which display a various information and multiple link means for connecting to a cyber mall for an e-commerce, multiple information provider servers that provide an information by being connected to the link means, and a system server that transmits the information provided by the multiple information provider servers to multiple users' computers and displays the information on the user's computer monitor; registering the information displayed on the user's computer monitor and data connected by the link means from the multiple information provider server; registrating a membership for the user; setting up a screen arrangement data by setting a position, size and time of the data to display various data registered through the information provider server on a user's computer monitor; transmitting and installing an intermediating program containing the screen arrangement data to the user's computer; transmitting and displaying data that are provided by the multiple information provider server and are displayed on the user's computer monitor by the condition set by the screen arrangement data; selecting anyone of the multiple link means displayed on the user's computer monitor by the intermediating program; and displaying data or a webpage connected to the link means selected by the user in the previous step.

In the membership registrating step, an authorization ID is issued by a membership registration at one time for a user, and a log-in is executed to the multiple registered cyber malls using the issued ID without additional membership registration for each cyber mall server.

The membership registrating step comprises the steps of: filling out an application form after connecting to a web server by a user through a user's computer which is connected to the internet followed by agreeing to a service contract;

registering a user ID after duplication check and a password;

registering personal information; setting a condition for settlement and delivery necessary in e-commerce; issuing an authorized ID which can be used for registered cyber malls using the registered membership ID; and registering the authorized ID to each registered cyber mall server DB.

In the method according to the present invention, personal member information is not disclosed when joining or withdrawing from a cyber mall because only the authorized ID is provided to the registered cyber malls while managing the personal information only at the system server.

The operation of the intermediating program comprises the steps of: loading the program by an automatic execution or user's loading as soon as the computer operation system is loaded after installing the program; waiting without being is not displayed on a screen until a user after being loaded at a main memory unit of a user's computer; inspecting a communication connection in the course of executing the intermediating program; performing an automatic connection when a communication connection is failed; connecting to a web server after communication connection; a step of first membership authorizating which permits the use of a web server based on the authorization information of a member; performing a membership registration when the user is not a registered member; and performing a re-authorization after a completion of the registration procedures.

The intermediating program is popped up upon the user's calling while being loaded at a main memory unit of the user's computer.

The method of calling the intermediating program is executed by assigning a hot key or a function key which calls the program on a specific key of a keyboard.

The method of calling the intermediating program using a mouse is characterized in that the intermediating program is popped up when a program button on a specific position of a screen is clicked.

The method of calling the intermediating program using a mouse is characterized in that the intermediating program is popped up when a specific position of a screen is touched.

The method of calling the intermediating program is characterized in that the intermediating program is popped up after a preset time since the last input.

When the intermediating program is called by a user, the method for intermediating e-commerce comprising the steps of: displaying an intermediating screen; re-examining communication connection; waiting a user's choice; a step of analyzing a function of the key on which a user makes an input; connecting to a information provider server of a company when there is a web code for the registered company; confirming if the user is a regular member by transmitting an authorization ID to the registered company; loading an e-commerce page; and proceeding an e-commerce, when the intermediating program is called by a user.

when a user selects a company which is not on the e-commerce list, a corresponding additional function is performed.

The method for intermediating the e-commerce further comprising the steps of:

searching a product by connecting to a server of a registered company by a member; preparing a list of products to be purchased; confirming the intention of purchase and payment of the member; requesting settlement information to the web server by a registered company; and

settling according to the information received by the registered company.

The method for intermediating the e-commerce further comprising the steps of:

confirming the intention of shipping to the member purchasing a product; receiving the shipping information stored in the web server; shipping the purchased product to the designated receiver, and notifying the shipping result to the member.

A user can perform e-commerce according to the present invention by calling an e-commerce program loaded in a memory of the user's computer or by using an automatically called and displayed e-commerce program when the operation of a user is delayed by a preset time.

The e-commerce according to the present invention can minimize the disclosure of personal information which can occur in the membership registration step or in the on-line settlement step by the eliminating membership registration and the log-in procedure for e-commerce for each shopping mall because when a user registers a system server once, the user can log-in all servers which are registered and connected to the system server without a separate authorization procedure.

### BRIEF DESCRIPTION OF THE DRAWINGS

FIG. 1 is a system block diagram to illustrate a system for intermediating electronic commerce according to the present invention.

FIG. 2 is an example of a screen for intermediating electronic commerce displayed on a monitor of a user's computer for a system and a method for intermediating electronic commerce according to the present invention.

FIG. 3 is a flow chart to illustrate a membership registration procedure according to the present invention.

FIG. 4 is a flow chart to illustrate a membership authorization procedure according to the present invention.

FIG. 5 is a flow chart to illustrate an electronic commerce procedure after membership authorization according to the present invention.

FIG. 6 is a flowchart to illustrate a calling procedure of an electronic commerce intermediating screen according to the present invention.

FIG. 7 is a flow chart to illustrate a method for providing an advertisement and an additional service to the user's computer according to the present invention.

### BEST MODE FOR CARRYING OUT THE INVENTION

A preferred embodiment of the invention will be described below with reference to the accompanying drawings.

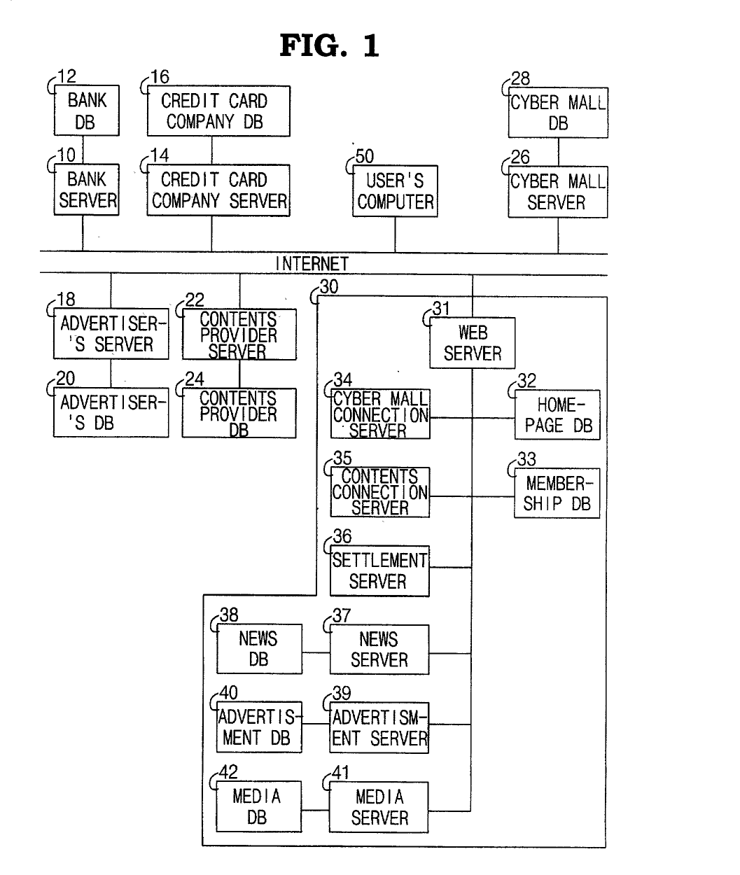

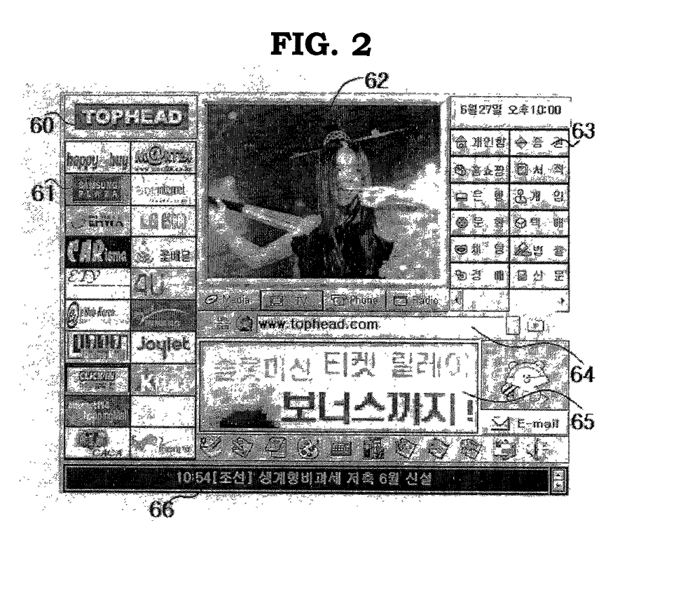

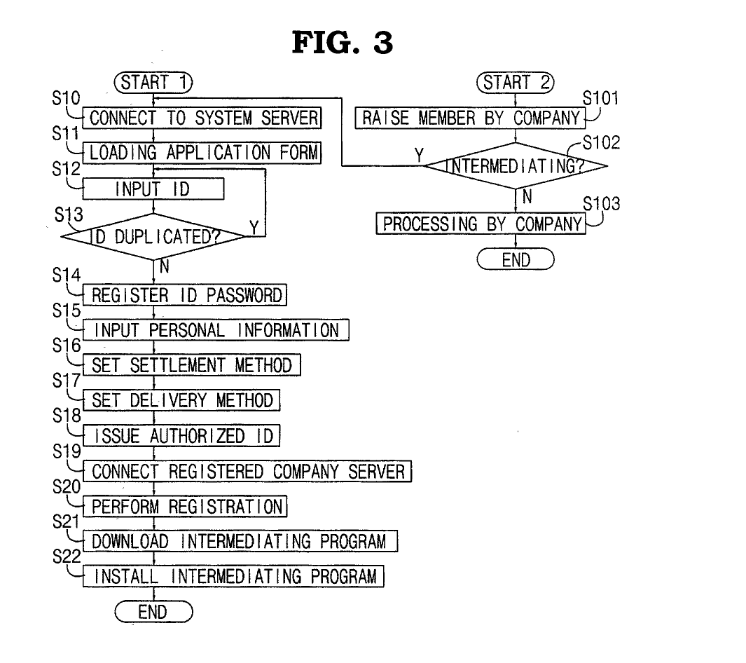

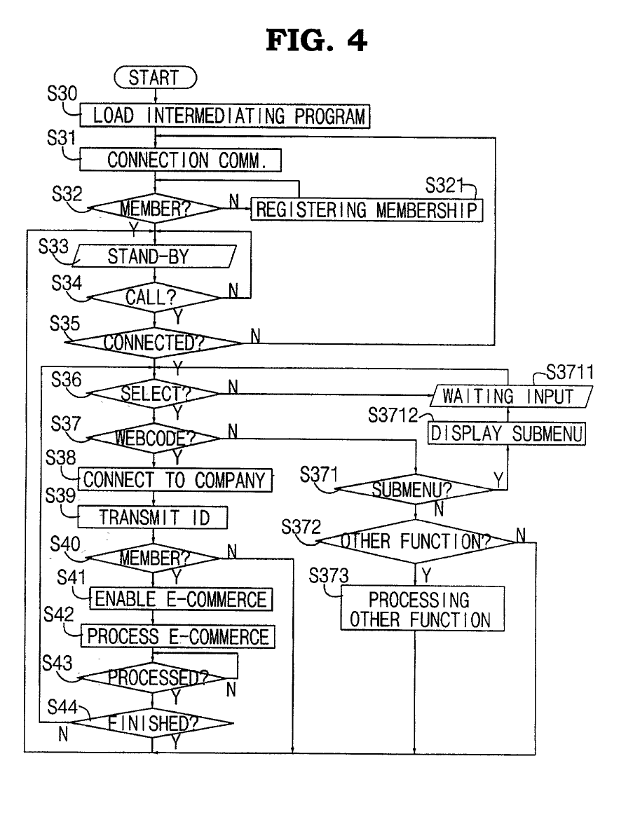

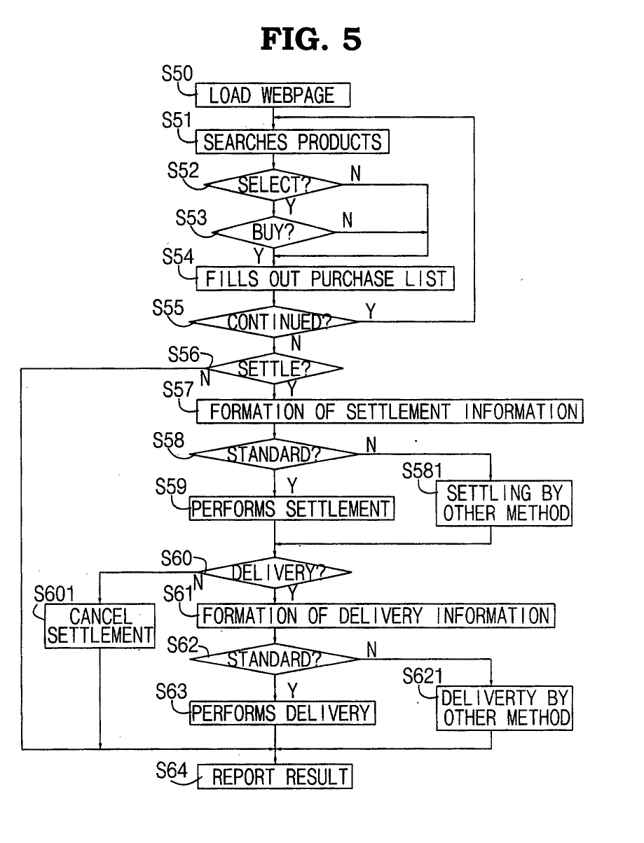

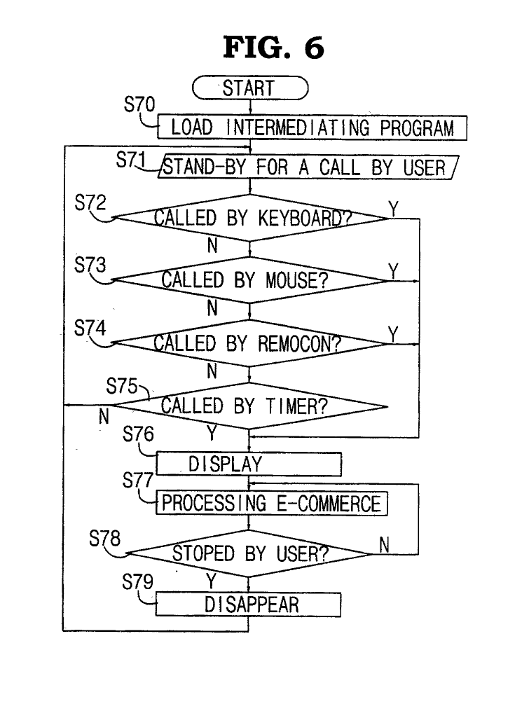

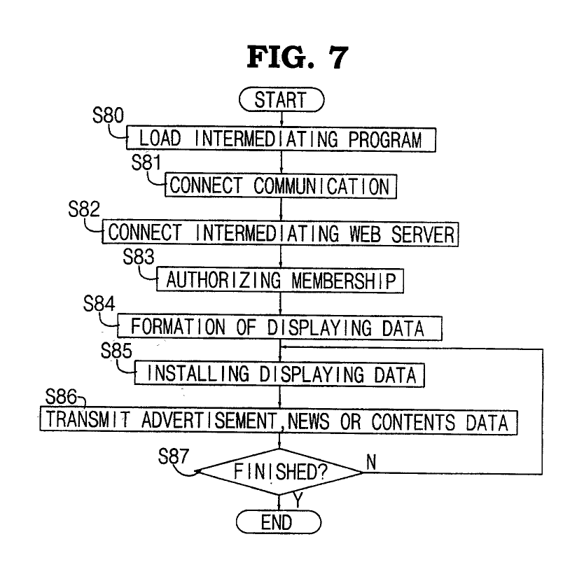

FIG. 1 is a system block diagram to illustrate a system for intermediating electronic commerce according to the present invention, FIG. 2 is an example of a screen for intermediating electronic commerce displayed on a monitor of a user's computer for a system and a method for intermediating electronic commerce according to the present invention, FIG. 3 is a flow chart to illustrate a membership registration procedure according to the present invention, FIG. 4 is a flow chart to illustrate a membership authorization procedure according to the present invention, FIG. 5 is a flow chart to illustrate an electronic commerce procedure after membership authorization according to the present invention, FIG. 6 is a flow chart to illustrate a calling procedure of an electronic commerce intermediating screen according to the present invention, and FIG. 7 is a flow chart to illustrate a method for providing an advertisement and an additional service to the user's computer according to the present invention.

The present invention allows logging in multiple cyber mall servers 26 through a system server 40 without a separate membership registration procedure. To achieve the purpose, multiple cyber mall servers 26 providing e-commerce and a cyber mall database(DB) 28 which is connected to the server and provides cyber mall data are connected through the internet.

Furthermore, a bank server 10 or a credit card company server 14 to authorize settlement in e-commerce in which a user is connected to the cyber mall server 26 through the user's computer 50 is linked to the system server 30.

The bank server 10 or the credit card server 14 settles payment by a separate settlement sever 36 which is connected to the system server 30, and the settled payment is transferred to an intermediary running the system server followed by distribution to each cyber mall operator.

Therefore, the user pays to the system server operator instead of the cyber mall operator.

Optionally, such a settlement may be carried out directly between the user and the cyber mall.

As described above, the information server which is connected to the system server 30 and provides data to the user computer 50 includes an advertiser server 18 and DB(20) which provides an advertisement to be displayed on the user's computer, a contents provider server 22 and DB(24) which provides various contents information, as well as the cyber mall server. In order to display them on the screen of the user computer 50, an intermediating screen is displayed as shown in FIG. 2.

As shown in FIG. 2, the intermediating screen includes a cyber mall banner 61 which is a cyber mall linking means connecting multiple cyber malls, a contents linking unit 63 which connects to contents provider server 22 providing various contents information, a moving image screen 62 which displays multimedia data, a URL address input window 64 in which a user can input a URL address directly without the linking means, an advertisement window 65 which displays advertisement that is provided by the advertiser's server 18, a news window 66 which displays news, and a system server connection window that connects the system server 30.

The screen illustrated in FIG. 2 is only an example and it can be modified by the request of a user or by the operation concept of the system server 30 operator.

Information exhibited through the intermediating screen is displayed by the control of the system server 30 which, as shown in FIG. 1, includes a web server 31 that connects the system server 30 to the internet, a homepage DB 32 that stores data such as bulletin board information necessary in the homepage operation of the web server, a membership DB 33 that stores information of members who utilize services by connecting to the system server 30, a cyber mall connection server 34 that connects the user's computer 50 to the cyber mall server 26 without a membership registration step upon the request of the user for the connection to the cyber mall server 26 through the user's computer, a contents connection server 35 that connects the user to the contents provider server 22 upon the user's request, a news server 37 that searches news displayed on the news window of the intermediating screen from the news provider server, a news DB 38 that stores news data searched from the news server 37, an advertisement DB 40 that stores advertisement data provided by the advertiser's server 18, an advertisement server 39 that displays the advertisement data stored in the advertisement DB 40 to the advertisement window 65 of the intermediating screen which is displayed on the user's computer 50 monitor, a media DB 42 that stores multimedia data which is displayed on the moving image window 62 of the intermediating screen, a media server 41 that displays the multimedia data stored in the media DB 42 to the moving image window 62 by predetermined schedule or upon the request of the user, and a settlement server 36 that settles payment on behalf of the user which is necessary in the settlement process of e-commerce between the user and the cyber mall server 26.

The e-commerce according to the system for intermediating e-commerce of the present invention is explained with reference to FIGS. 3 to 7.

First of all, in order to connect to the system server 30 of the present invention a user has to register and input basic data such as personal information, settlement and delivery method.

As shown in FIG. 3, the procedure for the membership registration necessary to utilize the system is either to use the intermediating method of the present invention or to register on each cyber mall.

The user to use the intermediating system of the present invention connects to the web server 31 of the system server 30 through the internet (S10).

The web server 31 receives the application form and agreement on the use of the server from a member by loading the application form and the service contract on the user's computer 50 (S11). The user inputs ID of his or her selection (S12). After confirming duplication of ID inputted by the user (S13), the ID and a password is registered (S14) followed by recording personal information of the user (S15).

After recording personal information, the user sets settlement and delivery method necessary in the e-commerce process (S16, S17).

Finishing the membership registration, the web server 31 issues an authorized ID by which the user can use services of the registered cyber malls 26 or contents provider servers 22 (S18), and performs registration to each registered company server (S19, S20).

The authorized ID is produced by combining a code of the registered company, a user ID and a security code to prevent the stealing of the ID. And the misuse of user's personal information can be prevented simply by requesting termination of service for a specific cyber mall server through the web server 31 by a user.

Furthermore, there is no inconvenience for a member when a list of changing companies is provided by an automatic registration of the authorized ID.

There is also no danger of disclosing personal member information because the personal member information is managed by the web server 31 and each cyber mall is provided with only the authorized ID.

The registration process is performed automatically between the system server and the registered company server, and a user can have the service by downloading (S21) an intermediating program (a program providing the screen as shown in FIG. 2) to use the intermediating system followed by installing it on the user's computer 50 (S22).

When a registered company has raised a member by itself (S101), the use of the intermediating system is asked in the member registration process (S102), and the member agreeing on the service of the intermediating system is registered as a member of the intermediating system through the registration process. If the user does not agree on the service of the intermediating system, the user can still register as a member of the selected company (S103).

After a proper membership registration procedure as above, e-commerce using a intermediating system as described in FIG. 4 can be performed.

Once the program is installed, the intermediating program is loaded in the main memory unit of the user's computer automatically or by the loading of a user after booting a computer operating system, and stays in stand-by state until being called by the user (S30).

When the intermediating program is run, a communication connection is inspected (S 31), an automatic connection is executed when necessary, and after connecting to the web server 31 a primary member authorization is performed (S32).

Furthermore, when the user is not a registered member, a registration procedure is executed (S321) and then the authorization procedure is performed again.

When a user is on other computer job, the intermediating program is not shown up and is not occupying working space, but it stays in a stand-by state waiting for a call and it is popped up in a monitor when there is a call from the user or there is no input for a preset time (S33).

When the program is called by a user (S34), the intermediating program is shown up on the user's computer monitor 50 as shown in FIG. 2.

The intermediating program re-inspects communication connection (S35), and waits for a user's selection.

Upon an input or a selection of a linking unit by a user (S36), it analyzes an allotted function of the corresponding input. If there is a web code connecting to a registered company (S37), it connects to an information provider's server of the company (S38), transmits an authorization ID (S39) for the second authorization and identifies membership (S40).

After a proper authorization process, a webpage enabling e-commerce is loaded (S41), and e-commerce process is started (S42, S43, S44).

When the user selects other field instead of a cyber mall for e-commerce in the selection process of a key input (S37), the program checks if there is a sub menu for the filed (S371). If the user selects other function without a sub menu (S372), the corresponding function is performed (S373). If there is a sub menu, the sub menu is displayed and the selected process is performed (S3711) and then again waits for the input from the user (S3712).

The intermediating program calling process by the user utilizes a keyboard or a mouse. As described in FIG. 6, after the intermediating program is loaded (S70), in stand-by state of waiting for a call user(S71), a hot key or a function key of calling the program can be assigned to a special key of the keyboard when the keyboard is used (S72). In case of using the mouse a button can be located on the user's computer monitor so that the program can be called when the button is pressed or is clicked by a mouse (S73).

Also, a separate remote controller can be used to call the program using the function key of the remote controller (S74).

When a timer is used, the program is called for a user after a preset time since the last input by a user (S75).

When the program is called either by a keyboard, a mouse or a timer, a screen like FIG. 2 is displayed on a monitor (S76), an e-commerce process is performed (S77). When the execution of the program is stopped by the order of the user (S78), the screen disappears (S79).

The e-commerce procedure after the second membership authorization (S40)as shown in FIG. 4 is illustrated in FIG. 5.

As shown in FIG. 5, when a web page provided by the cyber mall server 26 is loaded (S50), a member searches and selects a product from a registered company (S51˜S53), and fills out a purchase list (S54, S55). Upon the settlement intention by the member for purchasing (S56), the registered company requests and receives settlement information from the settlement server 36 of the system server 30 (S57), and performs settlement (S59) according to a corresponding standard S 58. If the settlement method is not specified, it settles the payment through an individual questioning process (S581).

Thereafter, a delivery for a user is confirmed (S60), and the settlement is withdrawn if delivery is not requested (S601). If delivery is requested, the delivery method for the member is confirmed (S61) from a member DB 33 connected to the system server 30, the product is delivered (S63) according to the delivery method as specified (S62) and the result is reported to the user (S64).

If the delivery method is not specified, the delivery method is determined by asking the user (S621).

As described above, the present invention provides a secure and convenient e-commerce between a buyer and a seller. Furthermore, according to the present invention an additional information acquisition chance as well as a utility function such as running a multimedia file for use off-line is provided by displaying a transmitted advertisement, news or contents data on an intermediating screen (S86) after a membership registration through a regular member registration process (S80-S83) followed by downloading (S84) and installing (S85) an intermediating screen from the web server for each user as shown in FIG. 7(S84, S85, S86).

Industrial Applicability

According to the present invention, a user can have services from companies which are registered on the system server by a membership registration at one time, and can join e-commerce under a different condition as specified by the user in the process of settlement and delivery setting, so that user's convenience is promoted and problems during the e-commerce can be minimized.

The present invention also provides e-commerce environment and intermediates a systematic and decent cyber mall for a user according to the call of the user irrespective of the operation of a separate web browser, and therefore it helps to abate inconvenience resulting from searching and inputting an address of a cyber mall, and helps to provide cheaper products for customers by curtailing extra cost of advertisement of registered cyber malls.

Still furthermore, the present invention provides a user with an easy chance of additional information acquisition as well as e-commerce.

Embodiments of the present invention are not limited only to the above, and it is evident that it can be diversely modified by a person who has ordinary knowledge in the art, without departing off the spirit of the present invention.

1. A system for intermediating an e-commerce comprising:
multiple Internet accessible multiple user's computers which allow electronic commerce through a program of displaying multiple link means for connecting between service environment display of a user's computer, a media display and a web page;
multiple cyber mall servers which are linked by the multiple link means displayed on a monitor of the user's computer and sell products by the electronic commerce; and a system server which provides and displays various information and the link means to the user's computer via the Internet, and connects each user's computer to the multiple cyber mall servers by means of a membership registration code input once from the user's computers without a separate authorization procedure for each cyber mall server.

2. The system for intermediating an e-commerce according to claim 1, wherein the system server comprises:
a web server which connects the system server to the Internet;
a homepage database(DB) which stores data including a bulletin board information which is necessary for a homepage operation of the web server;
a member DB which stores an information of members who are connected to the system server and uses a provided service; a cyber mall connection server which connects the cyber mall server to the user's computer without a separate membership registration step upon the request of the user to the cyber mall server;
a contents connection server which connects the user to a contents provider server upon the request of the user; a news server which searches news provider servers for news to be provided for the user;
a news DB which stores a news data found from the news server;
an advertisement DB which stores an advertisement data supplied from an advertiser's server;
an advertisement sever which transmits the advertisement data stored in the advertisement DB to the user's computer;
a media DB which stores a multimedia data to be displayed in the user's computer monitor;
a media server which transmits the multimedia data stored in the media DB to the user's computer at a scheduled time or upon the user's request; and
a settlement server which intermediates an information for settlement necessary for e-commerce between the user and the cyber mall server.

3. The system for intermediating an e-commerce according to claim 1, further comprising a bank server which pays-for the transaction between the user's computer and the cyber mall server and a credit card server which performs a settlement and authorization for transaction through a credit card.

4. The system for intermediating an e-commerce according to claim 1, further comprising multiple advertisers' servers which provide advertisements to be displayed on monitors of users' computers, and multiple contents provider servers which provide a various contents information.

5. A method for intermediating an e-commerce comprising the steps of:
constructing a network by multiple users' computers which display a various information and multiple link means for connecting to a cyber mall for an e-commerce, multiple information provider servers that provide an information by being connected to the link means, and a system server that transmits the information provided by the multiple information provider servers to multiple users' computers and displays the information on the user's computer monitor;
registering the information displayed on the user's computer monitor and data connected by the link means from the multiple information provider server;
registrating a membership for the user;
setting up a screen arrangement data by setting a position, size and time of the data to display various data registered through the information provider server on a user's computer monitor;
transmitting and installing an intermediating program containing the screen arrangement data to the user's computer;
transmitting and displaying data that are provided by the multiple information provider server and are displayed on the user's computer monitor by the condition set by the screen arrangement data;
selecting anyone of the multiple link means displayed on the user's computer monitor by the intermediating program; and
displaying data or a web page connected to the link means selected by the user in the previous step.

6. The method for intermediating an e-commerce according to claim 5, wherein in the membership registrating step, an authorization ID is issued by a membership registration at one time for a user, and a log-in is executed to the multiple registered cyber malls using the issued ID without additional membership registration for each cyber mall server.

7. The method for intermediating an e-commerce to claim 5, wherein the membership registrating step comprises the steps of:
filling out an application form after connecting to a web server by a user through a user's computer which is connected to the internet followed by agreeing to a service contract;
registering a user ID after duplication check and a password;
registering personal information;
setting a condition for settlement and delivery necessary in e-commerce;
issuing an authorized ID which can be used for registered cyber malls using the registered membership ID; and
registering the authorized ID to each registered cyber mall server DB.

8. The method for intermediating an e-commerce according to claim 7, wherein a personal member information is not disclosed when joining or withdrawing from a cyber mall because only the authorized ID is provided to the registered cyber malls while managing the personal information only at the system server.

9. The method for intermediating an e-commerce according to claim 5, wherein the operation of the intermediating program comprises the steps of:
loading the program by an automatic execution or user's loading as soon as the computer operation system is loaded after installing the program;
waiting without being is not displayed on a screen until a user after being loaded at a main memory unit of a user's computer;
inspecting a communication connection in the course of executing the intermediating program;
performing an automatic connection when a communication connection is failed;
connecting to a web server after communication connection;
a step of first membership authorizating which permits the use of a web server based on the authorization information of a member;
performing a membership registration when the user is not a registered member; and
performing a re-authorization after a completion of the registration procedures.

10. The method for intermediating an e-commerce according to claim 5, wherein the intermediating program is popped up upon the user's calling while being loaded at a main memory unit of the user's computer.

11. The method for intermediating an e-commerce according to claim 10, wherein the method of calling the intermediating program is executed by assigning a hot key or a function key which calls the program on a specific key of a keyboard.

12. The method for intermediating an e-commerce according to claim 10, wherein the method of calling the intermediating program using a mouse is characterized in that the intermediating program is popped up when a program button on a specific position of a screen is clicked.

13. The method for intermediating an e-commerce according to claim 10, wherein the method of calling the intermediating program using a mouse is characterized in that the intermediating program is popped up when a specific position of a screen is touched.

14. The method for intermediating an e-commerce according to claim 10, wherein the method of calling the intermediating program is characterized in that the intermediating program is popped up after a preset time since the last input.

15. The method for intermediating an e-commerce according to claim 10, further comprising the steps of:
displaying an intermediating screen;
re-examining communication connection;
waiting a user's choice; a step of analyzing a function of the key on which a user makes an input;
connecting to a information provider server of a company when there is a web code for the registered company;
confirming if the user is a regular member by transmitting an authorization ID to the registered company;
loading an e-commerce page; and
proceeding an e-commerce,
when the intermediating program is called by a user.

16. The method for intermediating an e-commerce according to claim 15, when a user selects a company which is not on the e-commerce list, a corresponding additional function is performed.

17. The method for intermediating an e-commerce according to claim 15, settle further comprising the steps of:
searching a product by connecting to a server of a registered company by a member;
preparing a list of products to be purchased;
confirming the intention of purchase and payment of the-member;
requesting settlement information to the web server by a registered company; and
settling according to the information received by the registered company.

18. The method for intermediating an e-commerce according to claim 15, further comprising the steps of:
confirming the intention of shipping to the member purchasing a product;
receiving the shipping information stored in the web server;
shipping the purchased product to the designated receiver, and
notifying the shipping result to the member.
